(19) United States
(12) Patent Application Publication
(10) Pub. No.: US 2006/0184958 A1
(43) Pub. Date: Aug. 17, 2006

(54) System and method for surface protection of optical-based digital storage media

(76) Inventor: J. Anthony Garcia, Colorado Springs, CO (US)

Correspondence Address: Law Offices of John D. Gugliotta, PE, Esq., 202 Delaware Building, 137 South Main Street, Akron, OH, 44308, US

(21) Appl. No.: 11/145,039

(22) Filed: Jun. 6, 2005

Related U.S. Application Data
(60) Provisional application No. 60/652,180, filed on Feb. 14, 2005.

(51) Int. Cl. G11B 7/24; G11B 23/03

(52) U.S. Cl. 720/719

(57) ABSTRACT

A type of conventional optical storage media such as a compact disc (CD), digital versatile disc (DVD) or any type of optical-based digital storage media is provided having a raised ring is provided along the outer perimeter of the media. The ring is approximately 1/64 to ⅛ of an inch higher than the recording surface and is approximately 3/32 of an inch in width. The ring is located in the blank space on the media where no recording is possible, thus the total playing time or storage space of the media is not affected.

### RELATED APPLICATIONS

The present invention claims priority benefit of U.S. Provisional Patent Application No. 60/652,180, filed on Feb. 14, 2005 and incorporated by reference as if fully rewritten herein.

### BACKGROUND OF THE INVENTION

1. Field of the Invention

The present invention relates generally to systems and methods for protection of surfaces, and, more particularly, to a system and method for surface protection of optical-based digital storage media.

2. Description of the Related Art

Modern technology continually produces products that revolutionize virtually every aspect of our lives. Of all of the many improvements produced by these ever evolving technological advancements, entertainment products are among the most popular and frequently used among the general public. Perhaps the most popular of these entertainment products of recent times is the compact disc or CD. Their superior fidelity, coupled with their ease of track access, and the wide variety of music styles available, make them the preferred choice when listening to music. While CD's are relatively durable, they are still subject to damage especially from scratches. “Jewel” cases provide some protection, but work only if the user is diligent about returning the CD to the case if it is not in the player. More often than not, many people are tempted to lay the CD on a table or other flat surface which is where scratches develop due to contact of the surface of the CD with the flat surface. Accordingly, there is a need for a means by which CD's can be protected from damage and scratches resulting from being set upon a flat surface in a manner which is quick, easy and effective.

DESCRIPTIVE KEY

| | | | |
|---|---|---|---|
| 10 | system and method for | 15 | optical media disk |
| | surface protection of optical- | 20 | access surface |
| | based digital storage media | 40 | horizontal surface |
| 25 | outer protective barrier | 45 | air space |
| 30 | inner protective barrier | | |
| 35 | spindle hole | | |

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an isometric view of the system and method for surface protection of optical-based digital storage media 10 as viewed from the playable side of an optical media disk 15, according to the preferred embodiment of the present invention;

FIG. 2 is a sectional view of the system and method for surface protection of optical-based digital storage media 10 as seen along a line I-I as shown in FIG. 1; and,

FIG. 3 is a side view of the system and method for surface protection of optical-based digital storage media 10 as seen resting on a horizontal surface 40.

### DESCRIPTION OF THE PREFERRED EMBODIMENTS

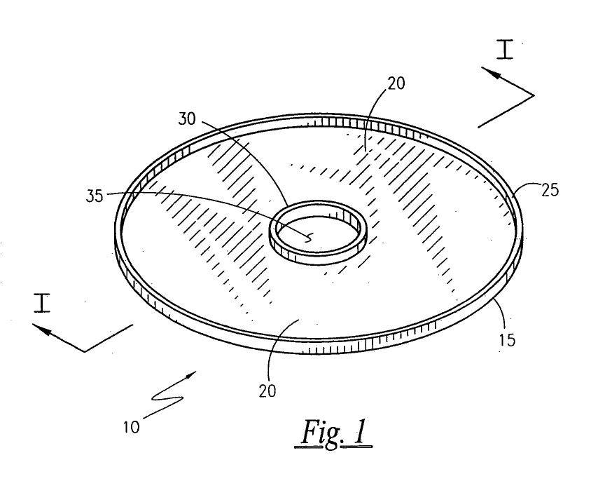

The best mode for carrying out the invention is presented in terms of its preferred embodiment, herein depicted within the FIGS. 1 through 3.

1. Detailed Description of the Figures

Referring now to FIG. 1 an isometric view of the system and method for surface protection of optical-based digital storage media 10 as viewed from the playable side of a optical media disk 15, according to the preferred embodiment of the present invention is disclosed. The optical media disk 15 can be any type of optical media and is envisioned to be of the type such as a compact disc CD), digital versatile disc (DVD) or any type of optical-based digital storage media that may be used in gaming systems or the like. It is capable of being used on writable or re-writable disks as well as read or play only discs commonly associated with movies or music albums. However, other or future types of optical media could also benefit from the features of the system and method for surface protection of optical-based digital storage media 10 and as such, should not be interpreted as a limiting factor of the present invention. An access surface 20 is clearly visible in this FIG. and is the surface through which the laser or other optical reading device accesses through a read or write condition, the digital information stored on the optical media disk 15. An outer protective barrier 25 is located around the outer perimeter of the optical media disk 15. The cross sectional size of the outer protective barrier 25 is envisioned to be approximately 1/64 to ⅛ of an inch higher than the access surface 20 and is approximately 3/32 of an inch in width, though such dimensions are not intended to be a limiting factor of the present invention. An inner protective barrier 30 is located around the perimeter of a spindle hole 35. The cross sectional size of the inner protective barrier 30 is envisioned to be approximately 1/64 to ⅛ of an inch higher than the access surface 20 and is approximately 3/32 of an inch in width, though such dimensions are not intended to be a limiting factor of the present invention. The spindle hole 35 is commonly used by drive motors to spin the optical media disk 15. It should be noted that either or both of the outer protective barrier 25 or inner protective barrier 30 provides the protective nature of the system and method for surface protection of optical-based digital storage media 10. As such the system and method for surface protection of optical-based digital storage media 10 can be implemented on a optical media disk 15 using one or the other of the outer protective barrier 25 or inner protective barrier 30. While the use of both the outer protective barrier 25 and inner protective barrier 30 will provide the most effective physical protection of the access surface 20 of the optical media disk 15 as will be seen below, it is not intended to restrict the use of outer protective barrier 25 or the inner protective barrier 30 on a separate individual basis.

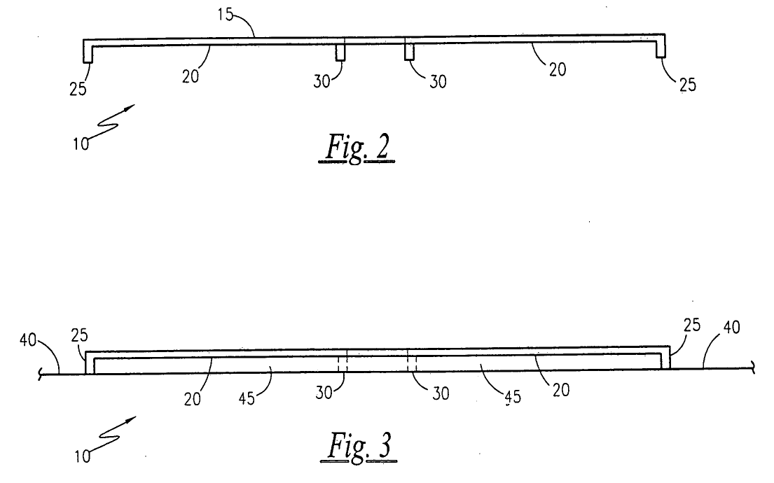

Referring next to FIG. 2, a sectional view of the system and method for surface protection of optical-based digital storage media 10 as seen along a line I-I as shown in FIG. 1 is depicted. This FIG. clearly depicts the recessed nature of the access surface 20 of the optical media disk 15 when compared to the protruding nature of both the outer protective barrier 25 and the inner protective barrier 30. It is envisioned that the small nature of the outer protective barrier 25 and the inner protective barrier 30 will not impact the requirements of current playback or recording devices which use the optical media disk 15. If such interferences should exist or occur, it is envisioned that the mechanica playback mechanism of the playback/reading or recording/writing device would be modified in a minor manner to accommodate the optical media disk 15 equipped with the system and method for surface protection of optical-based digital storage media 10.

Referring finally to FIG. 3, a side view of the system and method for surface protection of optical-based digital storage media 10 as seen resting on a horizontal surface 40. The horizontal surface 40 is envisioned to be almost any horizontal surface upon which a optical media disk 15 may commonly be set, but is envisioned to be a table top, a desk top, the top of a video monitor, atop of a optical media disk player, or even such surfaces as a vehicle dashboard, a kitchen sink, a chair or the like. The outer protective barrier 25 and the inner protective barrier 30 form supporting “leg-like” structures which hold the access surface 20 above the horizontal surface 40 forming an air space 45. As such, the air space 45 prevents any surface irregularities, dust, dirt or the like present on the horizontal surface 40 from scratching the access surface 20 of the optical media disk 15.

It is envisioned that other styles and configurations of the present invention can be easily incorporated into the teachings of the present invention, and only one particular configuration shall be shown and described for purposes of clarity and disclosure and not by way of limitation of scope.

2. Operation of the Preferred Embodiment

The preferred embodiment of the present invention can be utilized by the common user in a simple and effortless manner with little or no training. Those familiar with a conventional optical media disk 15 commonly used in computers, CD players, DVD players, gaming systems, and the like will notice no ready difference between the conventional optical media disk 15 and a optical media disk 15 equipped with the features of the system and method for surface protection of optical-based digital storage media 10. It is envisioned that the outer protective barrier 25 and the inner protective barrier 30 would be molded as an integral part of the optical media disk 15 during the manufacturing process of the optical media disk 15, but also may be added in a separate process using adhesive or other mechanical type fastener. When the user removes the optical media disk 15 equipped with the outer protective barrier 25 and/or the inner protective barrier 30 from a reading or writing device, it may be set with the access surface 20 down and facing a flat horizontal surface 40 without danger of damage, scratches, nicks or the like occurring to the access surface 20. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to to best explain the principles of the invention and its practical application, to thereby enable others skilled in the art to best utilize the invention and various embodiments with various modifications as are suited to the particular use contemplated.

What is claimed is:

1. An optical-based digital storage media comprising:
an optical media disc having an access surface through which an optical reading device accesses digital information stored thereon through a read or write condition;
an outer protective barrier circumscribing an outer perimeter of the optical media disk.

2. The optical-based digital storage media of claim 1, further comprising an inner protective barrier circumscribing an inner spindle hole formed by said optical media disc.

3. The optical-based digital storage media of claim 1, wherein said outer protective barrier extends outward from said access surface.

4. The optical-based digital storage media of claim 3, wherein said protection barrier extends outward from said access surface a distance from between approximately 1/64 to ⅛.

5. The optical-based digital storage media of claim 3, wherein said inner protective barrier extends outward from said access surface.

6. The optical-based digital storage media of claim 5, wherein said inner protection barrier extends outward from said access surface a distance from between approximately 1/64 to ⅛.

7. An optical-based digital storage media comprising:
an optical media disc having an access surface through which an optical reading device accesses digital information stored thereon through a read or write condition;
wherein said access surface is recessed when said disc is placed flat on a horizontal surface such as to form a space between said access surface and said horizontal surface.

8. The optical based storage media of claim 7, wherein said recess and said space are formed by an outer protective barrier circumscribing an outer perimeter of the optical media disk.

9. The optical-based digital storage media of claim 8, wherein said recess and said space are further formed by an inner protective barrier circumscribing an inner spindle hole formed by said optical media disc.

10. The optical-based digital storage media of claim 8, wherein said outer protective barrier extends outward from said access surface.

11. The optical-based digital storage media of claim 10, wherein said protection barrier extends outward from said access surface a distance from between approximately 1/64 to ⅛.

12. The optical-based digital storage media of claim 8, wherein said inner protective barrier extends outward from said access surface.

13. The optical-based digital storage media of claim 12, wherein said inner protection barrier extends outward from said access surface a distance from between approximately 1/64 to ⅛.

14. In an optical-based digital storage media having an optical disc, an access surface through which an optical reading device accesses digital information stored thereon through a read or write condition, a perimeter crircumscribing said disc, and a spindle hole formed by said disc, wherein the improvement comprises:
means for providing a protective offset outward from said access surface.

15. The improvement of claim 14, wherein said means for providing a protective offset comprises at least one protective barrier.

16. The improvement of claim 15, wherein said protective barrier circumscribes said outer perimeter.

17. The improvement of claim 15, wherein said protective barrier circumscribes said inner spindle hole formed.

18. The improvement of claim 15, wherein said protective offset extends outward from said access surface a distance from between approximately 1/64 to ⅛.

19. The improvement of claim 15, wherein said means for providing a protective offset comprises a space between said access surface and a horizontal surface upon which said disc is placed.

20. The improvement of claim 19, wherein said space is a width from between approximately 1/64 to ⅛.
